(19) United States
(12) Patent Application Publication
(10) Pub. No.: US 2023/0405679 A1
(43) Pub. Date: Dec. 21, 2023

(54) APPARATUS FOR PRODUCING A THREE-DIMENSIONAL WORK PIECE

(71) Applicant: SLM SOLUTIONS GROUP AG, Luebeck (DE)

(72) Inventors: Vera Gauzer, Luebeck (DE); Daniel Brück, Luebeck (DE); Jonas Prell, Luebeck (DE); Karsten Neumann, Luebeck (DE)

(21) Appl. No.: 18/035,220

(22) PCT Filed: Oct. 25, 2021
(86) PCT No.: PCT/EP2021/079515

§ 371 Date: May 3, 2023

(30) Foreign Application Priority Data
Nov. 9, 2020 (DE) 10 2020 129 473.5

(51) Int. Cl. B22F 10/28; B22F 12/45; B22F 12/00; B22F 12/70

(52) U.S. Cl. CPC B22F 10/28; B22F 12/45; B22F 12/38; B22F 12/70; B33Y 30/00

(57) ABSTRACT

An apparatus (10) for producing a three-dimensional work piece (46) by irradiating layers of a raw material powder with electromagnetic or particle radiation comprises a process chamber (16) accommodating a carrier (12) and a powder application device (14) for applying a layer of raw material powder onto the carrier (12). The apparatus (10) further comprises an irradiation unit (26) for selectively irradiating the layer of raw material powder with electromagnetic or particle radiation in accordance with a geometry of a corresponding layer of the work piece (18) to be produced. An absorption device (50) which is adapted to absorb heat radiation emitted upon selectively irradiating the layer of raw material powder with electromagnetic or particle radiation is provided in the process chamber (16) and/or in the irradiation unit (26) at such a position that it is capable of absorbing radiation occurring in an interior of the process chamber (16) and/or in an interior of the irraditation unit (26).

The invention is directed to an apparatus for producing a three-dimensional work piece by irradiating layers of a raw material powder with electromagnetic or particle radiation.

Powder bed fusion is an additive layering process by which pulverulent, in particular metallic and/or ceramic raw materials can be processed to three-dimensional work pieces of complex shapes. To that end, a raw material powder layer is applied onto a carrier and subjected to laser radiation in a site selective manner in dependence on the desired geometry of the work piece that is to be produced. The laser radiation penetrating into the powder layer causes heating and consequently melting or sintering of the raw material powder particles. Further raw material powder layers are then applied successively to the layer on the carrier that has already been subjected to laser treatment, until the work piece has the desired shape and size. Powder bed fusion may be employed for the production or repairing of prototypes, tools, replacement parts, high value components or medical prostheses, such as, for example, dental or orthopaedic prostheses, on the basis of CAD data.

An exemplary apparatus for producing three-dimensional work pieces by powder bed fusion as described in EP 3 321 003 B1 comprises a process chamber accommodating a carrier for receiving a raw material powder. An irradiation unit which comprises a radiation source and a plurality of optical elements is provided to selectively irradiate electromagnetic or particle radiation onto the raw material powder on the carrier in order to produce a work piece. A protective gas stream is directed through the process chamber for establishing a desired atmosphere within the process chamber and for discharging impurities from the process chamber.

Upon building up a three-dimensional work piece on the carrier of a powder bed fusion apparatus, the radiation energy introduced into the raw material powder causes the raw material powder to melt and/or sinter. Specifically, a melt pool of molten raw material is generated in a region where the radiation beam impinges on the raw material powder. Thermal radiation emitted from the irradiated powder bed may cause a temperature increase within the process chamber and consequently also a temperature increase in the irradiation unit.

As described in EP 3 067 132 A1, a temperature change within the irradiation unit may cause a temperature dependent change of specific optical properties of the optical elements of the irradiation unit. For example, the refractive index of an optical fiber, a lens or another optical element or the geometry, in particular a curvature or a radius of a lens may change in dependence on the temperature prevailing within the process chamber and hence the irradiation unit. Due to temperature-induced changes of the optical properties of the optical elements, a focus position of a radiation beam may be shifted along a beam path of the radiation beam.

It is an object of the present invention to provide an apparatus for producing a high-quality three-dimensional work piece by irradiating layers of a raw material powder with electromagnetic or particle radiation.

An apparatus for producing a three-dimensional work piece by irradiating layers of a raw material powder with electromagnetic or particle radiation comprises a process chamber accommodating a carrier. The apparatus further comprises a powder application device for applying a layer of raw material powder onto the carrier. For distributing the raw material powder layer on a surface of the carrier, the powder application device may be movable across the carrier. The carrier may be a rigidly fixed carrier. Preferably, however, the carrier is designed to be displaceable in a vertical direction, so that, with increasing construction height of the work piece, as it is built up in layers from the raw material powder, the carrier can be moved downwards in the vertical direction. The raw material powder applied onto the carrier is preferably a metallic powder, in particular a metal alloy powder, but may also be a ceramic powder or a powder containing different materials. The powder may have any suitable particle size or particle size distribution. It is, however, preferable to process powders of particle sizes <100 μm. The process chamber preferably is sealable against the ambient atmosphere.

The apparatus further comprises an irradiation unit for selectively irradiating the layer of raw material powder with electromagnetic or particle radiation in accordance with a geometry of a corresponding layer of the work piece to be produced. The irradiation unit for selectively irradiating electromagnetic or particle radiation onto the raw material powder layer may comprise a radiation beam source, in particular a laser beam source, and additionally may comprise at least one optical unit for splitting, guiding and/or processing at least one radiation beam emitted by the radiation beam source. The optical unit may comprise optical elements such as an object lens and a scanner unit, the scanner unit preferably comprising a diffractive optical element and a deflection mirror. The irradiation unit may irradiate the raw material powder layer with a single radiation beam. It is, however, also conceivable that the irradiation system irradiates two or more radiation beams onto the raw material powder layer.

An absorption device which is adapted to absorb radiation is provided in the process chamber and/or in the irradiation unit at such a position that it is capable of absorbing radiation occurring in an interior of the process chamber and/or in an interior of the irraditation unit. An “absorption device” in the sense of the present application is a device which absorbs radiation, in particular thermal radiation, electromagnetic radiation and/or particle radiation, and thus discharges said radiation from components arranged in the vicinity of the absorption device. Thermal radiation to be absorbed by the absorption device may be emitted from the powder bed, the built part of the workpiece, a heating unit and further heated up components. Electromagnetic radiation and/or particle radiation to be absorbed by the absorption device may be the radiation that is emitted for irradiating the layer of raw material powder. The electromagnetic and/or particle radiation may in particular be reflected from the powder bed defined by the layer of raw material powder applied onto the carrier.

The expression “in the process chamber and/or in the irradiation unit” designates an arrangement of the absorption device either in an interior space of the process chamber and/or the irradiation unit and/or an integration of at least a part of the absorption device in a component of the process chamber and/or the irradiation unit. For example, the absorption device may at least in part be integrated into a wall of the process chamber and/or the irradiation unit or the absorption device may at least in part be arranged in an opening provided in a wall of the process chamber and/or the irradiation unit. The absorption device may also at least in part be integrated into a component of the apparatus for producing a three-dimensional work piece which is arranged in the process chamber and/or the irradiation unit.

The absorption device may be defined by a single absorption element which may be arranged in the process chamber or the irradiation unit. It is, however, also conceivable that the absorption device comprises a plurality of absorption elements which may be distributed in the process chamber and/or in the irradiation unit.

The absorption device takes up radiation which otherwise would cause the optical elements of the irradiation unit to heat up. Consequently, the absorption device attenuates or even prevents temperature-induced changes of the optical properties of the optical elements of the irradiation unit as well as dislocations due to thermal distortions. An undesired shift of a focus position of a radiation beam along a beam path of the radiation beam, i.e. shift of the focus position in a z-axis direction thus may be reduced or even avoided. Similarly, an undesired shift of a spot position of the radiation beam, i.e. a shift of the spot position in a x-axis and/or a y-axis direction may be reduced or even avoided. This allows the production of high-quality work pieces which are less affected or even not at all affected by the above described temperature-induced focus position shift.

An absorption surface of the absorption device may face an interior of the process chamber and/or an interior of the irradiation unit. Consequently, the absorption device is capable of absorbing radiation occurring in the interior of the process chamber and/or in the interior of the irraditation unit in a particularly effective manner.

The absorption surface of the absorption device may have a hemispherical reflectance of less than 40%, preferably less than 20%, more preferably less than 10% and most preferably less than 5% for thermal radiation, i.e. for radiation energy at a wavelength ranging from 0.75 μm to 50 μm. Alternatively or additionally, the absorption surface of the absorption device may have a hemispherical reflectance of less than 40%, preferably less than 20%, more preferably less than 10% and most preferably less than 5% for radiation energy at a wavelength of the electromagnetic or particle radiation used for selectively irradiating the layer of raw material powder, in particular a wavelength ranging from 350 nm to 1100 nm, preferably 405-490 nm (blue), 490-575 nm (green) and/or 805-1100 nm (infrared).

Alternatively or additionally, an absorption surface of the absorption device may at least in part be anodized, coated, foiled, oxidized, structured and/or roughened, in particular laser black-marked. An anodized absorption surface layer may have a thickness of 0.5 μm to 150 μm. An absorption coating provided on the absorption device and forming the absorption surface of the absorption device may be a black and/or opaque coating or foil, like a black metallic or black ceramic coating or foil, and/or may have a thickness of 0.1 μm to 1 mm. A surface roughness of the absorption surface may be in the range of 0.1 μm to 10 μm.

It is, however, also conceivable that different absorption surfaces may differ in their hemispherical reflectance, in particular the hemispherical reflectance of an absorption surface in the process chamber may differ from the hemispherical reflectance of an absorption surface in the irradiation unit. Preferably, an absorption surface of an absorption device arranged in the process chamber is a good absorber for radiation energy at a wavelength of the electromagnetic or particle radiation used for selectively irradiating the layer of raw material powder, i.e. radiation energy at a wavelength emitted from a radiation source of the irradiation unit. Additionally or alternatively, an absorption surface of an absorption unit arranged in the irradiation unit may be a good absorber for thermal radiation, i.e. radiation at a wavelength in the range of 0.75 μm to 50 μm.

It is also conceivable that the absorption device or the absorption surface of the absorption device comprises or is made of a translucent material which absorbs radiation energy at a wavelength of the electromagnetic or particle radiation and in particular laser radiation which is used for selectively irradiating the layer of raw material powder. For example, the absorption surface of the absorption device may comprise or may be made of mineral glass or acrylic glass. The absorption surface of the absorption device may also covered by a translucent window made of a non-absorbing material. A cooling channel may be defined between the absorption surface and the translucent window. The cooling channel may be flown through with a cooling agent which may be an absorbing cooling agent such as, for example, water.

A reflexion device which is adapted to reflect radiation may be provided in the process chamber and/or in the irradiation unit at such a position that it is capable of reflecting radiation occurring in an interior of the process chamber and/or in an interior of the irraditation unit. A “reflexion device” in the sense of the present application is a device which reflects radiation, in particular thermal radiation, electromagnetic radiation and/or particle radiation, and thus deflects said radiation from components arranged in the vicinity of the reflexion device. The reflexion device may be defined by a single reflexion element, which may be arranged in the process chamber or the irradiation unit. It is, however, also conceivable that the reflexion device comprises a plurality of reflexion elements which may be distributed in the process chamber and/or in the irradiation unit.

The reflexion device may in particular be provided in regions of the process chamber and/or the irradiation unit were the thermal radiation, the electromagnetic radiation and/or the particle radiation emitted or reflected upon selectively irradiating the layer of raw material powder with electromagnetic or particle radiation would have a strong influence on the optical properties of the optical elements of the irradiation unit or where intense heating could lead to a severe deformation. Further, the reflexion device may be arranged so as to reflect the thermal radiation, the electromagnetic radiation and/or the particle radiation to regions of the process chamber and/or the irradiation unit were said radiation is less disruptive and/or where said radiation can be discharged in an easier manner. For example, the reflexion device may be provided in a region of the process chamber which is arranged adjacent to the irradiation unit and arranged so as to reflect radiation away from the irradiation unit and in the direction of the carrier supporting the raw material powder layer to be irradiated.

A reflexion surface of the reflexion device may face an interior of the process chamber and/or an interior of the irradiation unit. Consequently, the reflexion device is capable of reflecting radiation occurring in the interior of the process chamber and/or in the interior of the irraditation unit in a particularly effective manner.

A reflexion surface of the reflexion device may have a hemispherical reflectance of more than 60%, preferably more than 70%, more preferably more than 80% and most preferably more than 90% for thermal radiation, i.e. for radiation energy at a wavelength ranging from 0.75 μm to 50 μm. Alternatively or additionally, the reflexion surface of the reflexion device may have a hemispherical reflectance of more than 60%, preferably more than 70%, more preferably more than 80% and most preferably more than 90% for radiation energy at a wavelength of the electromagnetic or particle radiation used for selectively irradiating the layer of raw material powder, in particular a wavelength ranging from 350 nm to 1100 nm, preferably 405-490 nm (blue), 490-575 nm (green) and/or 805-1100 nm (infrared).

Alternatively or additionally, a reflexion surface of the reflexion device may at least in part be structured, foiled, coated and/or polished. A reflexion coating or foil provided on the reflexion device and forming the reflexion surface of the reflexion device may be a specular reflective and/or diffuse reflective. The reflexion surface of the reflexion device may be defined by a white opaque coating or foil and/or may have a thickness of 0.01 μm to 1 mm. A surface roughness of the reflexion surface may be less than 1 μm, preferably less than 0.2 μm.

It is, however, also conceivable that different reflexion surfaces may differ in their hemispherical reflectance, in particular the hemispherical reflectance of a reflexion surface in the process chamber may differ from the hemispherical reflectance of a reflexion surface in the irradiation unit. Preferably, a reflexion surface of a reflexion device arranged in the process chamber is a good reflector for radiation energy at a wavelength of the electromagnetic or particle radiation used for selectively irradiating the layer of raw material powder, i.e. radiation energy at a wavelength emitted from the radiation source of the irradiation unit. Additionally or alternatively, a reflexion surface of the reflexion device arranged in the irradiation unit may be a good reflector for thermal radiation, i.e. radiation at a wavelength in the range of 0.75 μm to 50 μm. A reflexion surface in the process chamber may also comprise retroreflector characteristics, for example, the reflexion surface may comprise a retroreflector foil.

At least one of the absorption device and the reflexion device may contain a material having thermal conductivity of at least 10 W/(m*K), preferably of at least 50 W/(m*K) and more preferably of at least 100 W/(m*K). This ensures a sufficient discharge of heat from the absorption device and/or the reflexion device.

Besides the thermal conductivity of the absorption device and the reflexion device, a distance between the absorption surface and the reflexion surface, respectively, and an element which serves to discharge energy from the absorption device and the reflexion device, respectively, may be suitably customised. The absorption device and the reflexion device, respectively, may be made from a different material than the element which serves to discharge energy from the absorption device and the reflexion device, respectively. Specifically, the length of the discharge path for the radiation energy and the thermal resistance along this discharge path should be minimised, since a temperature difference between a heat source and a heat drain depends on the heat flow and the overall from their assistance along the discharge path.

The absorption device may comprise at least one separate absorption element arranged in the process chamber and/or in the irradiation unit and which serves the sole purpose of absorbing radiation emitted and/or reflected upon selectively irradiating the layer of raw material powder with electromagnetic or particle radiation. For example, the absorption device may comprise at least one plate shaped absorption element which is provided with a suitable absorption surface.

Alternatively or additionally, the reflexion device may comprise at least one separate reflexion element arranged in the process chamber and/or in the irradiation unit and which serves the sole purpose of reflecting radiation emitted and/or reflected upon selectively irradiating the layer of raw material powder with electromagnetic or particle radiation. For example, the reflexion device may comprise at least one plate shaped reflexion element which is provided with a suitable reflexion surface.

Alternatively or additionally, the absorption device may comprise at least one absorption element, which is defined by a portion of a process chamber wall and/or a portion of an irradiation unit housing wall. For example, the absorption device may comprise at least one absorption element defined by a portion of a process chamber wall and/or a portion of an irradiation unit housing wall, which is provided with an anodized, coated and/or roughened surface defining the absorption surface.

Further, the reflexion device may comprise at least one reflexion element, which is defined by a portion of a process chamber wall and/or a portion of an irradiation unit housing wall. For example, the reflexion device may comprise at least one reflexion element defined by a portion of a process chamber wall, a portion of a support structure of the irradiation unit and/or a portion of an irradiation unit housing wall, which is provided with a coated and/or polished surface defining the reflexion surface.

The apparatus may further comprise a transmission element, which allows the transmission of the electromagnetic or particle radiation emitted by the irradiation device into the process chamber. The transmission element may, for example, be designed in the form of a window. Alternatively, the transmission element may comprise or consist of an optical element, in particular a lens, of the irradiation device. The transmission element may be arranged in a wall of the process chamber, in particular in a top wall portion of the process chamber. In a particular preferred embodiment of the apparatus, the transmission element is arranged in a region above a center of the carrier. For example, the transmission element may be integrated into a wall portion, in particular a top wall portion of the process chamber.

The material of the transmission element may be selected in dependence on the type of the radiation emitted by the irradiation device in order to ensure the desired transmissibility of the transmission element for the electromagnetic or particle radiation emitted by the irradiation device. For example, the transmission element may be made of a glass material or a suitable polymer material. If desired, the transmission element, in the region of a surface facing the interior of the process chamber, may be provided with a surface layer which minimizes the adhesion and deposition of welding smoke condensate onto the surface of the transmission element. In a particularly preferred embodiment of the apparatus, the transmission element is accommodated in a portion of a process chamber wall which defines at least a reflexion element of the reflexion device. Said process chamber wall portion may, for example, be a top wall portion of the process chamber.

The transmission element may comprise a surface structure and/or a coating on one or more surfaces, in particular on its entrance surface and/or on its exit surface. In a preferred embodiment, the transmission element may comprise an anti-reflective coating on its entrance surface, meaning the surface facing away from the process chamber. Additionally or alternatively, the transmission element may comprise a reflective coating on its exit surface, meaning the surface facing the process chamber, in order to prevent excessive heating of the transmission element. The reflective coating of the exit surface of the transmission element may have a reflectance of more than 40%, preferably more than 50%, more preferably more than 60% for radiation energy at a wavelength range of 0.75 μm to 50 μm. In a further preferred embodiment, the transmission element (including optionally coated and/or structured surfaces) is configured to transmit in a direction from the entrance surface to the exit surface at least 70%, in particular at least 90% of radiation at a wavelength of the electromagnetic or particle radiation used for selectively irradiating the layer of raw material powder, i.e. radiation at the wavelength emitted by the radiation source of the irradiation unit, in particular radiation at a wavelength in the range of 350 nm to 1100 nm, in particular 405-490 nm (blue), 490-575 nm (green) and/or 805-1100 nm (infrared).

In a particular preferred embodiment of the apparatus, all applicable process chamber wall portions which are subjected to the heat radiation emitted upon selectively irradiating the layer of raw material powder with electromagnetic or particle radiation define either an absorption device or a reflexion device. The term “applicable process chamber wall portions” in this context designates those process chamber wall portions which do not serve another functional purpose, for example the introduction of gas into the process chamber or the discharge of gas from the process chamber, which renders a process chamber wall portion unsuitable to define an absorption device or a reflexion device.

In a preferred embodiment of the apparatus, the process chamber comprises a first gas inlet for introducing a gas, in particular an inert gas, into the process chamber. For example, the first gas inlet may be defined by a porous process chamber wall portion and/or by an opening provided in a process chamber wall portion, in particular a process chamber sidewall portion. The gas may be provided by a first gas source which may comprise a first gas storage container and a first gas supply line. The first gas source may, for example, be an argon gas source or a nitrogen gas source. The first gas supply line may be connected to the first gas inlet. The process chamber may further be provided with a first gas outlet for discharging gas from the process chamber.

A gas stream which is introduced into the process chamber via the first gas inlet and discharged from the process chamber via the first gas outlet, upon being directed through the process chamber and in particular across the carrier, may take up and entrain particulate impurities such as soot, welding smoke, powder particles, etc. and discharge these particulate impurities from the process chamber. The first gas outlet and the first gas inlet may be connected to a recirculation line for recirculating gas exiting the process chamber via the first gas outlet back into the process chamber via the first gas inlet. A suitable filter device for filtering particulate impurities from the gas stream may be arranged in the recirculation line.

The first gas inlet may be configured to direct at least a part of a gas stream introduced into the process chamber via the first gas inlet to an absorption device and/or a reflexion device arranged in the process chamber in order to transfer heat from the absorption device and/or the reflexion device to the gas stream. Thus, the gas stream may be used to cool the absorption device and/or the reflexion device. The first gas source may be configured to provide cooled or heated gas. For this purpose, the first gas source may be in thermal contact with a first temperature control system which is configured to either transfer heat to the gas to be introduced into the process chamber or to discharge heat from the gas to be introduced into the process chamber.

During operation of the apparatus and the irradiation unit in order to produce a three-dimensional work piece by irradiating layers of a raw material powder with electromagnetic or particle radiation, the first temperature control system preferably is operated so as to cool the gas to be introduced into the process chamber. To the contrary, during a startup-phase of the apparatus before starting the irradiation unit and before starting the production of the three-dimensional work piece, the first temperature control system may be operated so as to heat the gas to be introduced into the process chamber in order to heat up the process chamber and the components of the apparatus in thermal contact therewith to a suitable operating temperature.

Preferably, the irradiation unit comprises a second gas inlet for introducing a gas, in particular an inert gas, into the irradiation unit. The gas may be provided by a second gas source which may comprise a second gas storage container and a second gas supply line. The second gas source may, for example, be a gas source which provides a gas providing for a high heat transfer coefficient while not increasing the flow speed. In particular, the second gas source may be a helium gas source. The second gas supply line may be connected to the second gas inlet. The irradiation unit may further be provided with a second gas outlet for discharging gas from the irradiation unit. The second gas outlet and the second gas inlet may be connected to a recirculation line for recirculating gas exiting the irradiation unit via the second gas outlet back into the irradiation unit via the second gas inlet. A suitable filter device, a heat exchanger and a conveying device may be arranged in the recirculation line. The conveying device may be designed in the form of a pump or a compressor. The recirculation circuit should be sealed so as to avoid a loss of the gas, e.g. the helium gas, provided by the second gas source.

The second gas inlet may be configured to direct at least a part of a gas stream introduced into the irradiation unit via the second gas inlet to an absorption device and/or a reflexion device arranged in the irradiation unit in order to transfer heat from the absorption device and/or the reflexion device to the gas stream. Thus, the gas stream may be used to cool the absorption device and/or the reflexion device. The second gas source may be configured to provide cooled or heated gas. For this purpose, the second gas source may be in thermal contact with a second temperature control system, which is configured to either transfer heat to the gas to be introduced into the irradiation unit or to discharge heat from the gas to be introduced into the irradiation unit.

During operation of the apparatus and the irradiation unit in order to produce a three-dimensional work piece by irradiating layers of a raw material powder with electromagnetic or particle radiation, the second temperature control system preferably is operated so as to cool the gas to be introduced into the irradiation unit. To the contrary, during a startup-phase of the apparatus before starting the irradiation unit and before starting the production of the three-dimensional work piece, the second temperature control system may be operated so as to heat the gas to be introduced into the irradiation unit in order to heat up the irradiation unit and in particular the optical elements arranged therein to a suitable operating temperature.

The first gas inlet of the process chamber and the second gas inlet of the irradiation unit may be connected to separate gas sources and/or separate temperature control systems for the process chamber and the irradiation unit as described above. It is, however, also conceivable to provide the apparatus with only one gas source and/or only one temperature control system. The first gas inlet of the process chamber and the second gas inlet of the irradiation unit then may be connected to the same gas source and/or the same temperature control system.

The absorption device may comprise cooling fins. Preferably, the cooling fins of the absorption device extend from the absorption surface and/or a surface of the absorption device, which is arranged opposite of the absorption surface. Thus, the cooling fins are configured to direct heat away from the absorption device and in particular from the absorption surface. In case the absorption device comprises one or more absorption elements, at least one of the absorption elements may be provided with cooling fins extending from the absorption surface and/or a surface of the absorption element, which is arranged opposite from the absorption surface.

Alternatively or additionally, the reflexion device may comprise cooling fins. Preferably, the cooling fins of the reflexion device extend from a surface of the reflexion device which is arranged opposite of the reflexion surface. Thus, the cooling fins are configured to direct heat away from the reflexion device and in particular from the reflexion surface. In case the reflexion device comprises one or more reflexion elements, at least one of the reflexion elements may be provided with cooling fins extending from a surface of the reflexion element which is arranged opposite from the reflexion surface.

The absorption device may comprise at least one tempering channel, which extends through a body of the absorption device and/or which extends adjacent and in thermal contact with the surface of the absorption device which is arranged opposite of the absorption surface. In case the absorption device comprises one or more absorption elements, at least one of the absorption elements may be provided with at least one tempering channel which extends through a body of the absorption element and/or which extends adjacent and in thermal contact with the surface of the absorption element which is arranged opposite of the absorption surface.

Alternatively or additionally, the reflexion device may comprise at least one tempering channel which extends through a body of the reflexion device and/or which extends adjacent and in thermal contact with the surface of the reflexion device which is arranged opposite of the reflexion surface. In case the reflexion device comprises one or more reflexion elements, at least one of the reflexion elements may be provided with at least one tempering channel which extends through a body of the reflexion element and/or which extends adjacent and in thermal contact with the surface of the reflexion element which is arranged opposite of the reflexion surface.

The tempering channel of the absorption device and/or the reflexion device may be flown through with a suitable temperature control fluid. The temperature control fluid may be a liquid temperature control fluid or a gaseous temperature control fluid, for example air. The tempering channel of the absorption device and/or the reflexion device may be in thermal contact with a third temperature control system which is configured to either transfer heat to the temperature control fluid flowing through the tempering channel or to discharge heat from the temperature control fluid flowing through the tempering channel.

During operation of the apparatus and the irradiation unit in order to produce a three-dimensional work piece by irradiating layers of a raw material powder with electromagnetic or particle radiation, the third temperature control system preferably is operated so as to cool the temperature control fluid flowing through the at least one tempering channel of the absorption device and/or the reflexion device. To the contrary, during a startup-phase of the apparatus before starting the irradiation unit and before starting the production of the three-dimensional work piece, the third temperature control system may be operated so as to heat the temperature control fluid flowing through the tempering channel of the absorption device and/or the reflexion device in order to heat up the process chamber and/or the irradiation unit and components of the apparatus in thermal contact therewith to a suitable operating temperature.

The third temperature control system may be formed integral with the first and/or the second temperature control system. It is, however, also conceivable to provide the apparatus with separate temperature control systems for the gas supplied to the process chamber and/or the irradiation unit and the temperature control fluid flowing through the tempering channel of the absorption device and/or the reflexion device.

The apparatus may comprise at least one further tempering channel. The at least one further tempering channel may extend through of a portion of a process chamber wall and/or a portion of an irradiation unit housing wall not forming at least a part of the absorption device and/or the reflexion device. Alternatively or additionally, the at least one further tempering channel may extend adjacent and in thermal contact with a portion of a process chamber wall and/or a portion of an irradiation unit housing wall not forming at least a part of the absorption device or the reflexion device.

The further tempering channel may be flown through with a suitable temperature control fluid. The temperature control fluid may be a liquid temperature control fluid or a gaseous temperature control fluid, for example air. Preferably, the further tempering channel is in thermal contact with the third temperature control system. Thus, the temperature of the temperature control fluid flowing through the further tempering channel may be controlled in the same manner as the temperature control fluid flowing through the at least one tempering channel of the absorption device and/or the reflexion device. It is, however, also conceivable that the further tempering channel is in thermal contact with a fourth temperature control system which may control the temperature of the temperature control fluid flowing through the further tempering channel independent of the temperature of the temperature control fluid flowing through the at least one tempering channel of the absorption device and/or the reflexion device.

At least one of the first, the second, the third and the fourth temperature control system may be controlled in dependence of one or more temperature sensors measuring one or more of a temperature of a surface, a temperature of a gas flow and a temperature of a temperature control fluid. Additionally or alternatively, at least one of the temperature control systems may be controlled in dependence on build job data, in particular in dependence on the proportion of the workpiece areas of the powder bed to be irradiated.

The absorption device may be configured and arranged so as to thermally expand without exerting a mechanical load on the process chamber and/or the irradiation unit. Alternatively or additionally, wherein the absorption device may be configured and arranged so as to thermally expand without affecting a location of the irradiation unit relative to the carrier.

This may be achieved, for example, by designing the absorption device in the form of a separate absorption element which is arranged in the process chamber and/or in the irradiation unit in a such a manner that thermally induced deformations of the absorption element are not transmitted to the process chamber and/or the irradiation unit. For example, the absorption element may be freely suspended in the process chamber and/or the irradiation unit. Alternatively or additionally, the absorption device may be connected to or integrated into the process chamber and/or the irradiation unit via expansion joints which prevent that thermally induced deformations of the absorption element are transmitted to the process chamber and/or the irradiation unit.

A gap having a width of at least 0.1 mm may be provided between an irradiation unit housing wall facing the process chamber or a support structure of the irradiation unit which faces the process chamber and a process chamber wall facing the irradiation unit. For example, the irradiation unit may comprise a suitable support structure in order to arrange the irradiation unit and in particular the irradiation unit housing wall facing the process chamber at the desired distance from the process chamber. Consequently, the irradiation unit can at least in part be thermally decoupled from the process chamber in order to prevent that excess heat is transferred from the process chamber to the irradiation unit. The gap may be flown through with a coolant, for example a cooled gas and/or a thermally insulating material may be arranged in the gap.

The absorption device may comprise at least one movable shielding element which is arranged in the process chamber and which is associated with a functional tool accommodated in the process chamber. Alternatively or additionally, the reflexion device may comprise at least one movable shielding element which is arranged in the process chamber and which is associated with a functional tool accommodated in the process chamber. For example, a movable shielding element of the absorption device or the reflexion device may be associated with the powder application device, gloves extending into the process chamber for handing purposes and/or a suction device for discharging raw material powder from the process chamber. The movable shielding element may be a simple plate shaped element. It is, however, also conceivable that the movable shielding element defines a kind of housing accommodating the functional tool. The movable shielding element protects the functional tool from the radiation emitted and/or reflected upon selectively irradiating the layer of raw material powder with electromagnetic or particle radiation.

Preferred embodiments of the invention will be described in greater detail with reference to the appended schematic drawings, wherein

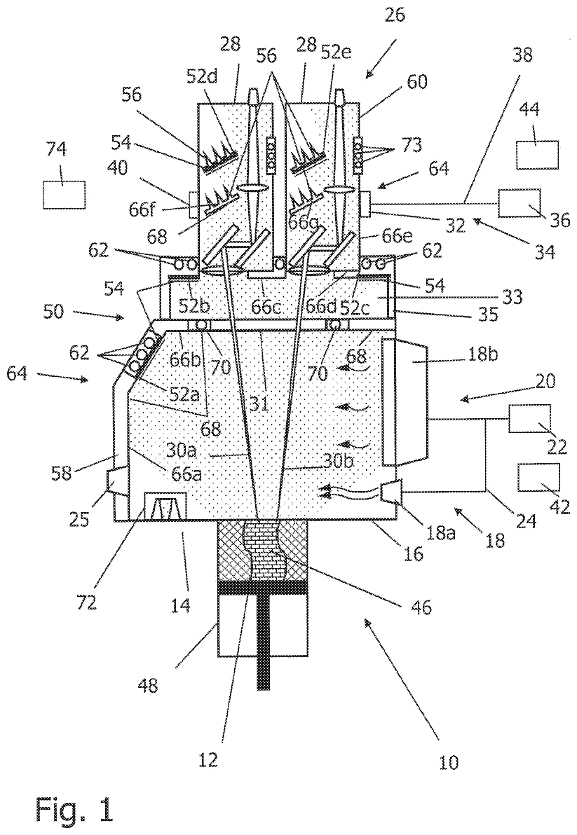

FIG. 1 shows an apparatus for producing a three-dimensional work piece by irradiating layers of a raw material powder with electromagnetic or particle radiation.

FIG. 1 shows an apparatus 10 for producing a three-dimensional work piece by an additive layering process. The apparatus comprises a carrier 12 and a powder application device 14 for applying a raw material powder onto the carrier 12. The carrier 12 and the powder application device 14 are accommodated within a process chamber 16 which is sealable against the ambient atmosphere. An internal atmosphere is established with a shielding gas supplied via a first gas inlet 18 of the process chamber 16. In the exemplary apparatus 10 shown in FIG. 1, the first gas inlet 18 is defined by a porous process chamber wall portion 18a forming a part of a process chamber sidewall and an opening 18b formed in the process chamber sidewall. The gas supplied into the process chamber 16 via the first gas inlet 18 is provided by a first gas source 20 which comprises a first gas storage container 22 and a first gas supply line 24. The first gas supply line 24 is connected to the first gas inlet 18.

The process chamber 16 further is provided with a first gas outlet 25 for discharging gas from the process chamber 16. During operation of the apparatus 10, a gas stream which is introduced into the process chamber 16 via the first gas inlet 18 and discharged from the process chamber 16 via the first gas outlet 25, upon being directed through the process chamber 16 and across the carrier 12, takes up and entrains particulate impurities such as soot, welding smoke, powder particles, etc. and discharges these particulate impurities from the process chamber 16. The first gas outlet 25 and the first gas inlet 18 are connected to a recirculation line (not shown). Via the recirculation line, gas exiting the process chamber 16 via the first gas outlet 25 is recirculated back into the process chamber 16 via the first gas inlet 18. Suitable filter devices (also not shown) for filtering particulate impurities from the gas stream may are arranged in the recirculation line.

The apparatus 10 further comprises an irradiation unit 26 for selectively irradiating electromagnetic or particle radiation onto the raw material powder applied onto the carrier 12. The irradiation device 26 comprises at least one radiation beam source, in particular a laser beam source. In the exemplary apparatus 10 shown in FIG. 1, the radiation source emits two radiation beams 30a, 30b which are processed in a suitable manner by a pair of optical units 28. Each optical unit 28 comprises optical elements such as an object lens and a scanner unit, the scanner unit comprising a diffractive optical element and/or at least one deflection mirror.

A transmission element 31 which allows the transmission of the radiation beams 30a, 30b emitted by the irradiation device 26 into the process chamber 16 is arranged in a top wall portion of the process chamber 16. A gap 33 having a width of at least 0.1 mm is provided between a portion of the irradiation unit housing wall 60 facing the process chamber 16 and a portion of the process chamber wall 58 facing the irradiation unit 26. In particular, the irradiation unit 26 comprises a suitable support structure 35 in order to arrange the optical components of the irradiation unit 26 and in particular the irradiation unit housing wall portion facing the process chamber 16 at the desired distance from the process chamber 16. Consequently, the irradiation unit 26 is at least in part be thermally decoupled from the process chamber 16.

The irradiation unit 26 comprises a second gas inlet 32 for introducing an inert gas, into the irradiation unit 26. The inert gas is provided by a second gas source 34 which comprises a second gas storage container 36 and a second gas supply line 38. The second gas supply line 38 is connected to the second gas inlet 32. The irradiation unit 26 is further be provided with a second gas outlet 40 for discharging gas from the irradiation unit 26.

The first and the second gas source 20, 34 are configured to provide cooled or heated gas. For this purpose, the first gas source 20 is in thermal contact with a first temperature control system 42 which is configured to either transfer heat to the gas to be introduced into the process chamber 16 or to discharge heat from the gas to be introduced into the process chamber 16. The second gas source 34 is in thermal contact with a second temperature control system 44 which is configured to either transfer heat to the gas to be introduced into the irradiation unit 26 or to discharge heat from the gas to be introduced into the irradiation unit 26.

During operation of the apparatus 10 for producing a three-dimensional work piece 46, a layer of raw material powder is applied onto the carrier 12 by means of the powder application device 14. In order to apply the raw material powder layer, the powder application device 14 is moved across the carrier 12. Then, the layer of raw material powder is selectively irradiated with electromagnetic or particle radiation in accordance with a geometry of a corresponding layer of the work piece 18 to be produced by means of the irradiation device 26.

The steps of applying a layer of raw material powder onto the carrier 12 and selectively irradiating the layer of raw material powder with electromagnetic or particle radiation in accordance with a geometry of a corresponding layer of the work piece 46 to be produced are repeated until the work piece 46 has reached the desired shape and size. The carrier 12 is displaceable in a vertical direction into a built cylinder 48 so that the carrier 12 can be moved downwards with increasing construction height of the work piece 48, as it is built up in layers from the raw material powder on the carrier 12. The carrier 12 can comprise a heater and/or a cooler.

During operation of the apparatus 10 and the irradiation unit 26 in order to produce the three-dimensional work piece 48 as described above, the first and the second temperature control systems 42, 44 are operated so as to cool the gas to be introduced into the process chamber 16 and the irradiation unit 26. To the contrary, during a startup-phase of the apparatus 10 before starting the irradiation unit 26 and before starting the production of the three-dimensional work piece 48, the first and the second temperature control systems 42, 44 are operated so as to heat the gas to be introduced into the process chamber 16 and the irradiation unit 26 in order to heat up the process chamber 16 and the irradiation unit 26 to a suitable operating temperature.

The apparatus 10 further comprises an absorption device 50 which is adapted to absorb radiation emitted and/or reflected upon selectively irradiating the layer of raw material powder with electromagnetic or particle radiation. In FIG. 1, the heat radiation emitted upon selectively irradiating the layer of raw material powder with electromagnetic or particle radiation is schematically indicated by the dotted pattern in the interior of the process chamber 16, in the gap 33 between the process chamber 16 and in the interior of the irradiation unit 26.

The absorption device 50 comprises a plurality of absorption elements 52a-e which are distributed in the process chamber 16 and in the irradiation unit 26. The absorption device 50, i.e. each of the absorption elements 52a-e, is provided with an absorption surface 54 which has a hemispherical reflectance less than 40%, preferably less than 20%, more preferably less than 10% and most preferably less than 5% for radiation energy at a wavelength ranging from 0.75 μm to 50 μm and/or at a wavelength of the electromagnetic or particle radiation used for selectively irradiating the layer of raw material powder, in particular a wavelength ranging from 350 nm to 1100 nm, preferably 405-490 nm, 490-575 nm and/or 805-1100 nm.

Specifically, the absorption surface 54 of each of the absorption elements 52a-e is anodized or coated with a black and/or opaque metallic or ceramic coating so as to provide an anodized absorption surface layer or an absorption coating having a thickness of 0.1 μm to 1 mm. A surface roughness of the absorption surface is in the range of 0.1 μm to 10 μm. The absorption device 50, i.e. each of the absorption elements 52a-e, contains a material having thermal conductivity of at least 10 W/(m*K), preferably of at least 50 W/(m*K) and more preferably of at least 100 W/(m*K).

Further, the absorption surface 54 of the absorption device 50, i.e. the absorption surface 54 of each of the absorption elements 52a-e faces an interior of the process chamber 16 or an interior of the irradiation unit 26.

In particular, the absorption device 50 comprises two separate absorption elements 52d, 52e which comprise a plate shaped body and which are arranged in the irradiation unit 26. Said two absorption elements 52d, 52e are provided with cooling fins 56 extending from a surface of the absorption elements 52d, 52e which is arranged opposite of the absorption surface 54. Further, the absorption device 50 comprises an absorption element 52a which is defined by a portion of a process chamber wall 58 and two absorption elements 52b, 52c which are defined by a portion of the support structure 35 of the irradiation unit 26. Each of the absorption elements 52a, 52b, 52c comprises a tempering channel 62 which extends through a body of the absorption element 52a, 52b, 52c. The absorption element 52a may be made of a translucent material. Further, the absorption element 52a may also be arranged in a recess formed in the process chamber wall 58.

The apparatus 10 further comprises a reflexion device 64 which is adapted to reflect heat and laser radiation emitted and reflected upon selectively irradiating the layer of raw material powder with electromagnetic or particle radiation. The reflexion device 64 comprises a plurality of reflexion elements 66a-g which are distributed in the process chamber 16 and in the irradiation unit 26. The reflexion device 64, i.e. each of the reflexion elements 66a-g is provided with a reflexion surface 68 which has a hemispherical reflectance of more than 60%, preferably more than 70%, more preferably more than 80% and most preferably more than 90% for radiation energy at a wavelength ranging from 0.75 μm to 50 μm and/or at a wavelength of the electromagnetic or particle radiation used for selectively irradiating the layer of raw material powder, in particular a wavelength ranging from 350 nm to 1100 nm, preferably 405-490 nm, 490-575 nm and/or 805-1100 nm. Specifically, the reflexion surface 68 of each of the reflexion elements 66a-g is coated with a white opaque coating or polished so as to provide a reflexion coating having a thickness of 0.01 μm to 1 mm. A surface roughness of the reflexion surface is less than 1 μm. The reflexion device 64, i.e. each of the reflexion elements 66a-g, contains a material having thermal conductivity of at least 10 W/(m*K), preferably of at least 50 W/(m*K) and more preferably of at least 100 W/(m*K).

Further, the reflexion surface 68 of the reflexion device 64, i.e. the reflexion surface 68 of each of the reflexion elements 66a-g faces an interior of the process chamber 16 or an interior of the irradiation unit 26.

In particular, the reflexion device 64 comprises reflexion elements 66a, 66b defined by portions of the process chamber wall 58 which, at a surface facing an interior of the process chamber 16, are provided with a reflective coating. The reflexion element 66b is defined by a top portion of the process chamber wall 58 which accommodates the transmission element 31. Further, the reflexion device 64 comprises a reflexion element 66c defined by a portion of the support structure 35 of the irradiation unit 26 which, at a surface facing the process chamber 16, is provided with a reflective coating. The reflexion elements 66a-66c may comprise retroreflector characteristics and therefore reflect heat and laser radiation from the powder bed back to the powder bed.

Moreover, the reflexion device 64 comprises reflexion elements 66d, 66e defined by portions of the irradiation unit housing wall 60 which, at a surface facing an interior of the irradiation unit 26, are provided with a reflective coating, causing heat radiation to be reflected away from deformation critical portions of the irradiation unit housing wall 60 further into the irradiation unit 26 to less sensitive areas. Each of the reflexion elements 66b, 66c comprises a tempering channel 70 which extends through a body of the reflexion elements 66b, 66c. The reflexion device 64 also comprises two separate reflexion elements 66g, 66f which comprise a plate shaped body and which are arranged in the irradiation unit 26. Said two reflexion elements 66g, 66f are provided with cooling fins 56 extending from a surface of the reflexion elements 66g, 66f which is arranged opposite of the reflexion surface 68. The reflexion elements 66g, 66f may also comprise concave reflexion surfaces for dispersing reflected radiation.

Finally, the reflexion device 64 comprises a movable shielding element 72 which is arranged in the process chamber 16 and which is associated with a functional tool accommodated in the process chamber 16. In the exemplary apparatus 10 shown in FIG. 1, the functional tool associated with the movable shielding element 72 is the powder application device 14. The movable shielding element 72, at its outer surface, is provided with a reflective coating so as to define a reflexion surface 68.

The apparatus 10 comprises a further tempering channel 73 which extends through of a portion of the irradiation unit housing wall 60 not forming at least a part of the absorption device 50 and/or the reflexion device 64. The tempering channels 62, 70 of the absorption device 50 and the reflexion device 64 and the further tempering channel 73 are flown through with a suitable temperature control fluid and are in thermal contact with schematically illustrated a third temperature control system 74. The third temperature control system 74 is configured to either transfer heat to the temperature control fluid flowing through the tempering channels 62, 70 and the further tempering channel 73 or to discharge heat from the temperature control fluid flowing through the tempering channels 62, 70 and the further tempering channel 73.

During operation of the apparatus 10 and the irradiation unit 26 in order to produce the three-dimensional work piece 46 by irradiating layers of a raw material powder with electromagnetic or particle radiation, the third temperature control system 74 is operated so as to cool the temperature control fluid flowing through the tempering channels 62, 70 of the absorption device 50 and the reflexion device 64 and the further tempering channel 73. To the contrary, during a startup-phase of the apparatus 10 before starting the irradiation unit 26 and before starting the production of the three-dimensional work piece 48, the third temperature control system 74 is operated so as to heat the temperature control fluid flowing through the tempering channels 62, 70 of the absorption device 50 and the reflexion device 64 and the further tempering channel 73 in order to heat up the process chamber 16 and the irradiation unit 26 to a suitable operating temperature.

In order to further control the temperature of the absorption device 50 in the reflexion device 64, the first gas inlet 18 is configured to direct at least a part of the gas stream introduced into the process chamber 16 via the first gas inlet 18 to the absorption element 52, the reflexion elements 66a, 66b and the movable shielding element 72 in order to transfer heat from the absorption element 52, the reflexion elements 66a, 66b and the movable shielding element 72 to the gas stream. Thus, the gas stream flowing through the process chamber 16 may be used to cool the elements of the absorption device 50 and the reflexion device 64 which are arranged in the process chamber 16.

Similarly, the second gas inlet 37 is configured to direct at least a part of the gas stream introduced into the irradiation unit 26 via the second gas inlet 37 to the absorption elements 52c, 52d and the reflexion elements 66d-g in order to transfer heat from the absorption elements 52c, 52d and the reflexion elements 66d-g to the gas stream. Thus, the gas stream may be used to cool the elements of the absorption device 50 and the reflexion device 64 which are arranged in the irradiation unit 26.

1-15. (canceled)

16. Apparatus for producing a three-dimensional work piece by irradiating layers of a raw material powder with electromagnetic or particle radiation, the apparatus comprising:
a process chamber accommodating a carrier and a powder application device for applying a layer of raw material powder onto the carrier; and
an irradiation unit for selectively irradiating the layer of raw material powder with electromagnetic or particle radiation in accordance with a geometry of a corresponding layer of the work piece to be produced,
wherein an absorption device which is adapted to absorb radiation is provided in the process chamber and/or in the irradiation unit at such a position that it is capable of absorbing radiation occurring in an interior of the process chamber and/or in an interior of the irraditation unit.

17. The apparatus of claim 16,
wherein an absorption surface of the absorption device faces an interior of the process chamber and/or an interior of the irradiation unit; and/or
wherein an absorption surface of the absorption device has a hemispherical reflectance of less than 40%, preferably less than 20%, more preferably less than 10% and most preferably less than 5% for radiation energy at a wavelength ranging from 0.75 μm to 50 μm and/or at a wavelength of the electromagnetic or particle radiation used for selectively irradiating the layer of raw material powder, in particular a wavelength ranging from 350 nm to 1100 nm, preferably 405-490 nm, 490-575 nm and/or 805-1100 nm; and/or
wherein an absorption surface of the absorption device is at least in part anodized, coated, foiled oxidized, structured and/or roughened, in particular laser black-marked.

18. The apparatus of claim 16,
wherein a reflexion device which is adapted to reflect radiation is provided in the process chamber and/or in the irradiation unit at such a position that it is capable of reflecting radiation occurring in an interior of the process chamber and/or in an interior of the irraditation unit.

19. The apparatus of claim 18,
wherein a reflexion surface of the reflexion device faces an interior of the process chamber and/or an interior of the irradiation unit; and/or
wherein a reflexion surface of the reflexion device has a hemispherical reflectance of more than 60%, preferably more than 70%, more preferably more than 80% and most preferably more than 90% for radiation energy at a wavelength ranging from 0.75 μm to 50 μm and/or at a wavelength of the electromagnetic or particle radiation used for selectively irradiating the layer of raw material powder, in particular a wavelength ranging from 350 nm to 1100 nm, preferably 405-490 nm, 490-575 nm and/or 805-1100 nm; and/or
wherein a reflexion surface of the reflexion device is at least in part structured, foiled, coated and/or polished.

20. The apparatus of any one claim 16,
wherein at least one of the absorption device and the reflexion device contains a material having thermal conductivity of at least 10 W/(m*K), preferably of at least 50 W/(m*K) and more preferably of at least 100 W/(m*K).

21. The apparatus of claim 16,
wherein the absorption device comprises at least one separate absorption element arranged in the process chamber and/or in the irradiation unit; and/or
wherein the reflexion device comprises at least one separate reflexion element arranged in the process chamber and/or in the irradiation unit.

22. The apparatus of claim 16,
wherein the absorption device comprises at least one absorption element defined by a portion of a process chamber wall and/or a portion of an irradiation unit housing wall; and/or
wherein the reflexion device comprises at least one reflexion element defined by a portion of a process chamber wall, a portion of a support structure of the irradiation unit and/or a portion of an irradiation unit housing wall.

23. The apparatus of claim 16,
further comprising a transmission element which allows the transmission of the electromagnetic or particle radiation emitted by the irradiation unit into the process chamber, wherein the transmission element in particular is accommodated in a portion of a process chamber wall which defines a reflexion element of the reflexion device.

24. The apparatus of claim 16,
wherein the process chamber comprises a first gas inlet for introducing a gas which is provided by a first gas source into the process chamber,
wherein the first gas inlet is configured to direct at least a part of a gas stream introduced into the process chamber via the first gas inlet to an absorption device and/or a reflexion device arranged in the process chamber in order to transfer heat from the absorption device and/or the reflexion device to the gas stream; and/or
wherein the first gas source is configured to provide cooled or heated gas.

25. The apparatus of claim 16,
wherein the irradiation unit comprises a second gas inlet for introducing a gas which is provided by a second gas source into the irradiation unit,
wherein the second gas inlet is configured to direct at least a part of a gas stream introduced into the process chamber via the second gas inlet to an absorption device and/or a reflexion device arranged in the irradiation unit in order to transfer heat from the absorption device and/or the reflexion device to the gas stream; and/or
wherein the second gas source is configured to provide cooled or heated gas.

26. The apparatus of claim 16,
wherein the absorption device comprises cooling fins which in particular extend from the absorption surface and/or a surface of the absorption device which is arranged opposite of the absorption surface; and/or
wherein the reflexion device comprises cooling fins which in particular extend from a surface of the reflexion device which is arranged opposite of the reflexion surface.

27. The apparatus of claim 16,
wherein the absorption device comprises at least one tempering channel which extends through a body of the absorption device and/or which extends adjacent and in thermal contact with the surface of the absorption device which is arranged opposite of the absorption surface; and/or
wherein the reflexion device comprises at least one tempering channel which extends through a body of the reflexion device and/or which extends adjacent and in thermal contact with the surface of the reflexion device which is arranged opposite of the reflexion surface.

28. The apparatus of claim 16,
wherein the absorption device is configured and arranged so as to thermally expand without exerting a mechanical load on the process chamber and/or the irradiation unit; and/or
wherein the absorption device is configured and arranged so as to thermally expand without affecting a location of the irradiation unit relative to the carrier.

29. The apparatus of claim 16,
wherein a gap having a width of at least 0.1 mm is provided between a portion of an irradiation unit housing wall facing the process chamber or a support structure of the irradiation unit which faces the process chamber and a portion of a process chamber wall facing the irradiation unit.

30. The apparatus of claim 16,
wherein the absorption device comprises at least one movable shielding element which is arranged in the process chamber and which is associated with a functional tool accommodated in the process chamber; and/or
wherein the reflexion device comprises at least one movable shielding element which is arranged in the process chamber and which is associated with a functional tool accommodated in the process chamber.
